(19) United States
(12) Patent Application Publication
(10) Pub. No.: US 2026/0134226 A1
(43) Pub. Date: May 14, 2026

(54) Workflow Context Extraction

(71) Applicant: Opinr, Inc., Wilmington, DE (US)

(72) Inventor: Rahul Sunil, Thiruvananthapuram (IN)

(21) Appl. No.: 19/000,833

(22) Filed: Dec. 24, 2024

(30) Foreign Application Priority Data
Nov. 11, 2024 (IN) 202411086827

(51) Int. Cl. G06F 40/40; G06F 40/205

(52) U.S. Cl. CPC G06F 40/40; G06F 40/205

(57) ABSTRACT

Methods, apparatuses, and computer readable medium are disclosed that perform or are configured to cause a computer to perform workflow context extraction. An implementation of workflow context extraction includes receiving a natural language instruction to modify a structured workflow representation, invoking a first large language model to identify a function and one or more parameters usable to specifically identify one or more elements referred to by a portion of the natural language instruction based on a first prompt including the natural language instruction and a description of available functions and available parameters, invoking the function using the one or more parameters to produce a list of one or more identified elements, and invoking a second large language model to generate an output instruction to update the structured workflow representation based on a second prompt including the natural language instruction and the list of one or more identified elements.

### CROSS-REFERENCE TO RELATED APPLICATIONS

This application claims priority to Indian Provisional Patent Application No. 202411086827, filed Nov. 11, 2024, which is incorporated herein in its entirety by reference.

### BACKGROUND

Large language models may be utilized to synthesize an output based on a prompt including a natural language instruction. The output generated by a large language model may, however, suffer from hallucinations or inaccuracies due to limitations of the large language model.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a computing system which includes a question answer platform according to implementations of this disclosure.

FIG. 2 is a block diagram of an example of an internal configuration of a computing device usable in a computing system according to implementations of this disclosure.

FIG. 3 is a block diagram of an example of an implementation of workflow context extraction in a workflow platform.

FIG. 4 is a flowchart of an example process of workflow content extraction.

### DETAILED DESCRIPTION

Aspects of this disclosure relate to workflow context extraction. In a workflow system, a workflow may be described using a structured workflow representation. The structured workflow representation may be in a pre-determined format to enable the workflow system to read the structured workflow representation to display a user interface depicting the workflow, to manage the use of the workflow and to execute and/or track tasks relating to the workflow. The workflow representation may, for example, be stored in a JavaScript Object Notation Format (JSON). For example, the workflow may describe a series of tasks that must be performed in order, or based on more complex interdependencies between tasks.

One difficulty with utilizing a workflow system is establishing the structured workflow representation that is used to store, display, track and otherwise implement a workflow. The information stored in the structured workflow representation may be voluminous and complex. Errors in the structured workflow representation may result in the structured workflow representation being unusable. The structured workflow representation may, for example, be generated manually by entering or modifying the structured workflow representation directly (e.g., in JSON format), or through a user interface (e.g., by manipulating user interface elements that result in the creation or modification of associated JSON elements correlating to the manipulated user interface elements). Such ways of editing or creating structured workflow representations are time consuming and error prone and consume substantial compute, memory, and power resources over that time period to permit the manual editing of the structured workflow representation.

An improved way of creating or editing structured workflow representations is to use a large language model to transform a natural language description of a workflow to a corresponding structured workflow representation. One way of implementing such a transformation is to provide a prompt to a large language model including one or more examples of natural language descriptions of a workflow with one or more tasks with the corresponding expected structured workflow representation result and a natural language description input that is to be transformed into a structured workflow representation.

Problems associated with using a large language model to transform a natural language input to a structured workflow representation includes the tendency of a large language model to hallucinate (e.g., produce unexpected results unmoored from the provided prompt) and the potential for exponentially increased compute and memory usage as the number of input tokens to the large language model increases. For example, if a natural language input refers in the aggregate to a group of elements in an existing structured workflow representation (e.g., based on a characteristic of such elements), the generality or lack of specificity of the reference may result in a hallucinated output instead of a correct output.

Problems such as these may be mitigated by using workflow context extraction in a multiple step process to improve the accuracy of the output structured workflow representation and reduce the size of the prompt, and thus the associated memory and compute, in producing the output structured workflow representation. For example, in implementations of this disclosure, a first prompt including an input natural language instruction is used as input to a first large language model to produce a function and parameters usable to identify a list of elements of a structured workflow representation. The first prompt can omit the input structured workflow representation. The identified function is invoked using the identified parameters in order to process the structured workflow representation to produce the listing of elements. A second prompt including the natural language instruction, and the listing of elements is provided to a second large language model to produce an output instruction to update the structured workflow representation. The second prompt can omit the structured workflow representation. The output instruction can be used to produce an updated structured workflow representation which can be merged with the structured workflow representation to effectuate the update(s) requested by the natural language instruction.

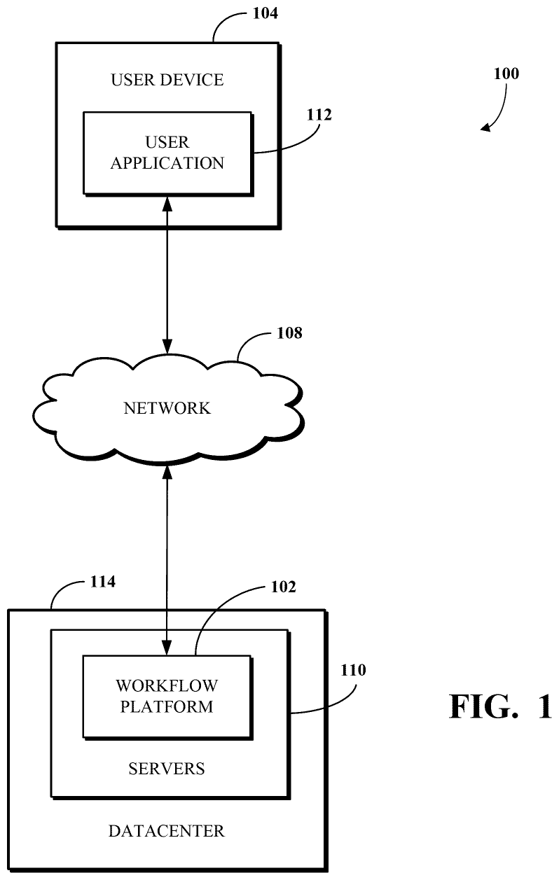

To describe some implementations in greater detail, reference is first made to examples of hardware and software structures used to implement a workflow system. FIG. 1 is a block diagram of an example of a computing system 100 which includes a workflow platform 102. The workflow platform 102 includes software for processing workflows and may, for example, include software for generating workflows, presenting workflows in user interfaces, and executing and tracking workflow tasks.

The user device 104 is a computing device capable of accessing the workflow platform 102 over the network 108, which may be or include, for example, the Internet, a local area network (LAN), a wide area network (WAN), a virtual private network (VPN), or another public or private means of electronic computer communication. For example, the user device 104 may be a mobile phone, a tablet computer, a laptop computer, a notebook computer, a desktop computer, or another suitable computing device. In some cases, the user device 104 may be registered to or otherwise associated with a customer of the workflow platform 102. The workflow platform 102 may be created and/or operated by a service provider and may have one or more customers, which may each be a public entity, private entity, or another corporate entity or individual that purchases or otherwise uses software services of the workflow platform 102. Without limitation, the workflow platform 102 can support hundreds or thousands of customers, and each of the customers may be associated with one or more user devices, such as the user device 104.

The workflow platform 102 is implemented using one or more servers 110, such as application servers and database servers. The servers 110 can each be a computing device or system, which can include one or more computing devices, such as a desktop computer, a server computer, or another computer capable of operating as a server, or a combination thereof. In some implementations, one or more of the servers 110 can be a software implemented server implemented on a physical device, such as a hardware server. In some implementations, a combination of two or more of servers 110 can be implemented as a single hardware server or as a single software server implemented on a single hardware server. For example, an application server and a database server can be implemented as a single hardware server or as a single software server implemented on a single hardware server. In some implementations, the servers 110 can include servers other than application servers and database servers, for example, media servers, proxy servers, and/or web servers.

For example, an application server may run software services deliverable to user devices such as the user device 104. For example, the application servers of the servers 110 can implement web server software to provide user access to provide a user interface to display workflows and tasks including the status of workflows and tasks from workflow platform 102.

In some implementations, the workflow platform 102 may be on-premises software run at a site operated by a private or public entity or individual associated with the user device 104. For example, the data sources 106 may in whole or in part be sources available at that site and then network 108 may be a LAN which connects the data sources 106 with the servers 110.

In some implementations, an instance of the workflow platform can be implemented in whole or in part in a public or private cloud including servers that provides compute, memory, network, and other resources as a service. For example, an instance may be used to provide workflow services to a single customer (e.g., single-tenant) or multiple customers (e.g., multi-tenant). In the case where a multi-tenant configuration is utilized, technological measures may be put in place to prevent data related to one customer from being used for or disclosed to another customer.

The servers 110 are located at a datacenter 114. The datacenter 114 can represent a geographic location, which can include a facility, where the one or more servers are located. Although a single datacenter 114 including one or more servers 110 is shown, the computing system 100 can include a number of datacenters and servers or can include a configuration of datacenters and servers different from that generally illustrated in FIG. 1. For example, and without limitation, the computing system 100 can include tens of datacenters, and at least some of the datacenters can include hundreds or another suitable number of servers. In some implementations, the datacenter 114 can be associated or communicate with one or more datacenter networks or domains. In some implementations, such as where the workflow platform 102 is on-premises software, the datacenter 114 may be omitted.

The network 108, the datacenter 114, or another element, or combination of elements, of the system 100 can include network hardware such as routers, switches, other network devices, or combinations thereof. For example, the datacenter 114 can include a load balancer for routing traffic from the network 108 to various ones of the servers 110. The load balancer can route, or direct, computing communications traffic, such as signals or messages, to respective ones of the servers 110. For example, the load balancer can operate as a proxy, or reverse proxy, for a service, such as a service provided to user devices such as the user device 104 by the servers 110. Routing functions of the load balancer can be configured directly or via a domain name service (DNS). The load balancer can coordinate requests from user devices and can simplify access to the workflow platform 102 by masking the internal configuration of the datacenter 114 from the user devices. In some implementations, the load balancer can operate as a firewall, allowing or preventing communications based on configuration settings. In some implementations, the load balancer can be located outside of the datacenter 114, for example, when providing global routing for multiple datacenters. In some implementations, load balancers can be included both within and outside of the datacenter 114.

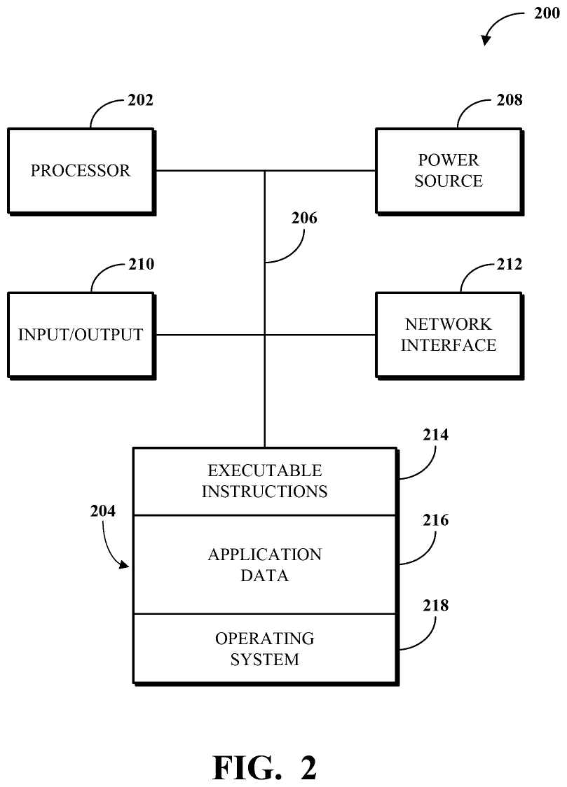

FIG. 2 is a block diagram of an example internal configuration of a computing device 200 usable with a computing system, such as the computing system 100 shown in FIG. 1. The computing device 200 may, for example, implement one or more of the user device 104 or one of the servers 110 of the computing system 100 shown in FIG. 1.

The computing device 200 includes components or units, such as a processor 202, a memory 204, a bus 206, a power source 208, input/output devices 210, a network interface 212, other suitable components, or a combination thereof. One or more of the memory 204, the power source 208, the input/output devices 210, or the network interface 212 can communicate with the processor 202 via the bus 206.

The processor 202 may include a central processing unit, such as a microprocessor, and can include single or multiple processors having single or multiple processing cores. The processor 202 may also include a GPU or TPU that is optimized to perform calculations needed to operate a language model. Alternatively, the processor 202 can include another type of device, or multiple devices, now existing or hereafter developed, configured for manipulating or processing information. For example, the processor 202 can include multiple processors interconnected in one or more manners, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory of the memory 204 can be random access memory (RAM) (e.g., a DRAM module, such as DDR SDRAM) or another form of volatile memory. In another example, the non-volatile memory of the memory 204 can be a disk drive, a solid state drive, flash memory, phase-change memory, or another form of non-volatile memory configured for persistent electronic information storage. Generally speaking, with currently existing memory technology, volatile hardware provides for lower latency retrieval of data and is more scarce (e.g., due to higher cost and lower storage density) and non-volatile hardware provides for higher latency retrieval of data and has greater availability (e.g., due to lower cost and high storage density). The memory 204 may also include other types of devices, now existing or hereafter developed, configured for storing data or instructions for processing by the processor 202. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 214, application data 216, and an operating system 218. The executable instructions 214 can include one or more application programs, which can be loaded or copied, in whole or in part, from non-volatile memory to volatile memory to be executed by the processor 202. For example, the executable instructions 214 can include instructions for performing some or all of the techniques of this disclosure. The application data 216 can include user data, database data (e.g., database catalogs or dictionaries), or the like. In some implementations, the application data 216 can include functional programs, such as a web browser, a web server, a database server, another program, or a combination thereof. The operating system 218 can be, for example, Microsoft Windows®, Mac OS X®, or Linux®; an operating system for a mobile device, such as a smartphone or tablet device; or an operating system for a non-mobile device, such as a mainframe computer.

The power source 208 includes a source for providing power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The input/output devices 210 include one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 212 provides a connection or link to a network (e.g., the network 108 shown in FIG. 1). The network interface 212 can be a wired network interface or a wireless network interface. The computing device 200 can communicate with other devices via the network interface 212 using one or more network protocols, such as using Ethernet, transmission control protocol (TCP), internet protocol (IP), power line communication, an IEEE 802.X protocol (e.g., Wi-Fi, Bluetooth, ZigBee, etc.), infrared, visible light, general packet radio service (GPRS), global system for mobile communications (GSM), code-division multiple access (CDMA), Z-Wave, another protocol, or a combination thereof.

The foregoing description of computing device 200 includes a number of components that may be found in a computer. However, depending on the implementation, some components may be added, deleted, or modified. For example, in some implementations, (e.g., such as with respect to server 110), human interface devices (e.g., input/output devices 210) may be omitted.

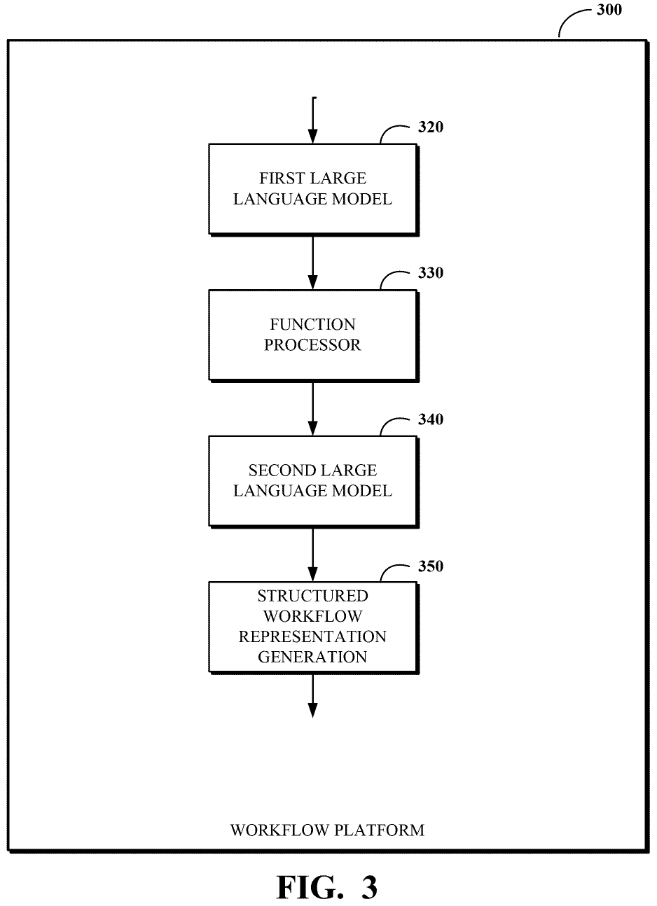

FIG. 3 is a block diagram of an example of an implementation of workflow context extraction in a workflow platform 300, which may, for example, be the workflow platform 102 shown in FIG. 1. The workflow platform 300 is accessible by user devices, for example, the user device 104 using the web browser software 112 (or a client application, as applicable) shown in FIG. 1. The workflow platform 300 includes components for generating and using workflows. As shown, workflow platform 300 includes first large language model 320, function processor 330, second large language model 340, and structured workflow representation generation 350.

As used herein, the term “component” can refer to a hardware component (e.g., infrastructure, such as a switch, router, server, modem, processor, integrated circuit, input/output interface, memory, storage, power supply, biometric reader, media reader, other sensor, or the like, or combinations thereof), a software component (e.g., a platform application, web application, client application, other software application, module, tool, routine, firmware process, or other instructions executable or interpretable by or in connection with one or more hardware components, or the like, or combinations thereof), or combinations thereof. A component can also refer to a computing feature such as a document, model, plan, socket, virtual machine, or the like, or combinations thereof. A component, such as a hardware component or a software component, can refer to a physical implementation (e.g., a computing device, such as is shown in FIG. 2) or a virtual implementation (e.g., a virtual machine, container, or the like that can, for example, execute on a physical device and mimic certain characteristics of a physical device) of one or more of the foregoing.

The components 320 through 350 may be implemented using one or more servers, for example, the servers 110 of the datacenter 114 shown in FIG. 1. One or more of the components 320 through 350 may be implemented using one or more application servers and database servers.

First large language model 320 is invoked to identify a function and parameter(s) based on a first prompt. For example, the natural language instruction may be provided as input to a machine learning model, such as a large language model, in order to produce an identification of a function and parameters that may be used to produce a list of elements. For example, the elements may include fields in a structured workflow representation. For example, the prompt may be used to provide examples of natural language instructions and associated functions and parameters usable to produce such as list for the example natural language instructions. For example, the prompt may include a dictionary of available functions and available parameters. For example, the prompt may provide a description of a syntax to be used when the output is generated. The prompt may exclude the structured workflow representation.

In some implementations, the first large language model may be a self-hosted large language model stored and executed on one or more of servers 110 in datacenter 114, for example, such as a Large Language Model Meta AI model. In some implementations, the first large language model may be a third-party hosted large language model stored and/or executed on servers outside of datacenter 114 and which may, for example be provided as a service through an API, for example, such as a General Purpose Transformer model. The large language models used for the first large language model (and other large language models used herein) generally will have hundreds of millions or billions of parameters and will require substantial memory (e.g., gigabytes of RAM and terabytes of disk storage) and compute (e.g., gigaFLOPs (floating point operations) or teraFLOPs).

In some implementations a workflow can have multiple swimlanes (also called stepgroups). Swimlanes are a collection of steps, and steps are a collection of fields. A workflow, including its constituent elements, may be edited using a user interface by selecting, for example, a workflow, swimlane, step, or field, and providing a natural language instruction to act on the selected elements. In some implementations, the elements of a workflow are identified by a unique name. In some implementations, the uniqueness of a name may be based on the context (e.g., a field name may only be unique with respect to its step, and not with respect to the entire workflow).

In some implementations, fields have properties which define it they are mandatory, vital or optional, read-only or not, hidden or not, filterable or not, whether there is a regex validation and a regex message or not, or combinations thereof. Depending on the implementation there may be different, additional, or fewer properties. These properties may be changable on field level using change_field or these properties can also be changed by adding visibility rules if a condition is mentioned. In some implementations, hiding a field means changing the ‘hidden’ property of the field to true. Removing field visibility rule means removing the conditions based on which that field will be made hidden dynamically. For example, if a natural language instruction includes something like ‘hide a field in a step’, that means it is instructing to set the hidden property of that field to true. For example, if a natural language instruction something like ‘remove field visibility rule’ from a field, that means it is instructing to remove the visibility constraint on that field.

In some implementations, a field is a data element within a step that captures, displays or manipulates specific information. Fields may be used to ask and capture inputs and display information, for example in a user interface. There are several field types available to accommodate diverse data need s. Common field types include: integer, decimal, text, char_field, html, bool, date, naive_Date, url, radio, single_select, multi_select, slider, cascader, checkbox, grouped_checkbox, business_unit, region, currency, paragraph, alert (Info, Description, Error, Warning, Success), phone, email, file, attachment, multi_file, word_document, s3_object, break, section_break, user_workflow, lc_message, table, array, dynamic_group_json, google_address_search, json, wizard_section, pdf_viewer, iframe, visualization and system field.

In some implementations, if a natural language instruction includes an explicit reference by name to all implicated elements in the structured workflow representation, workflow context extraction may not be required and no function may be identified, in which case, the invocation of a function is skipped and the second large language model may be invoked without using an output from an invoked function.

In some implementations, a structured workflow representation can be implemented using a Javascript Object Notation Format (JSON), for example, based on or like the excerpt of an example structured workflow representation below:

```
{
  “auto_integration_call_field_tags”: [ ],
  “bulk_actions”: [ ],
  “stepgroups”: {
    “0”: {
      “dynamic_group_names”: [ ],
      “name”: “Business Requestor”,
      “static_groups”: [ ],
      “steps”: { },
      “tag”: “business_requester_12345”
    }
  },
  “name”: “ESG Child”,
  “kind”: {
    “available_statuses”: [
      “In Progress - AT”
    ],
    “default_status”: “In Progress - AT”,
    “name”: “ESG Child”,
    “tag”: “felixjunior”,
    “visible_to_static_groups”: [ ],
    “permissions”: {
      “dynamic_groups”: { },
      “static_groups”: {
        “Admin”: [
          “add_workflow”
        ]
      }
    }
  },
  “file_paths”: [ ]
}
```

In some implementations, an example included in the first prompt may include the following mapping an example natural language instruction to an example function and example one or more parameters and may include a series of other examples based on or like this example:

```
Q: All hidden fields should be optional.
A: [
  {
    “function_arguments”: {
    “field_selection”: {
    “is_hidden”: true,
    “is_multiple”: true
    }
  },
  “function_name”: “get_fields_by_selection”
  }
]
```

In some implementations, a dictionary of available functions and available parameters may include an entry for a get_fields_by_selection function and associated parameters or other functions based on or like the following:

```
{
  “type”: “function”,
  “function”: {
    “name”: “get_fields_by_selection”,
    “parameters”: {
      “type”: “object”,
      “required”: [
        “field_selection”
      ],
      “properties”: {
          “field_selection”: {
          “type”: “object”,
          “properties”: {
              “name”: {
                  “type”: “string”,
                  “description”: “Name of the field.”
              },
              “step”: {
                “type”: “string”,
                “description”: “Step name under which the field resides.”
              },
              “regex”: {
                “type”: “string”,
                “description”: “Regex for matching thefields to select multiple
                fields.”
              },
              “top_n”: {
                “type”: “integer”,
                “default”: 0,
                “description”: “Number of fields from the absolute top within
                the process.”
              },
              “hidden”: {
                “type”: “boolean”,
                “description”: “If true, selects hidden fields.”
              },
              “bottom_n”: {
                “type”: “integer”,
                “default”: 0,
                “description”: “Number of fields from the absolute bottom
                within the process.”
              },
              “disabled”: {
                “type”: “boolean”,
                “description”: “If true, selects disabled fields.”
              },
              “position”: {
                “type”: “object”,
                “properties”: {
                  “relation”: {
                    “enum”: [
                      “between”,
                      “before”,
                      “after”
                    ],
                    “type”: “string”,
                    “description”: “The type of relative position of the
                    target field.”
                  },
                  “reference”: {
                      “type”: “string”,
                      “description”: “The name of the field after which
                      the target needs to be modified.”
                  },
                  “second_reference”: {
                    “type”: “string”,
                    “description”: “The second reference field when
                    ‘relation’ is ‘between’.”
                  }
                },
                “description”: “Selects fields based on relative position to other
                fields.”
            },
            “stepgroup”: {
              “type”: “string”,
              “description”: “Stepgroup name under which the field resides.”
            },
            “field_types”: {
              “type”: “array”,
              “items”: {
                “enum”: [
                    “integer”,
                    “decimal”,
                    “text”,
                    “char_field”,
                    “html”,
                    “bool”,
                    “date”,
                    “naive_date”,
                    “url”,
                    “radio”,
                    “single_select”,
                    “multi_select”,
                    “slider”,
                    “cascader”,
                    “checkbox”,
                    “grouped_checkbox”,
                    “business_unit”,
                    “region”,
                    “currency”,
                    “paragraph”,
                    “alert”,
                    “phone”,
                    “email”,
                    “file”,
                    “attachment”,
                    “multi_file”,
                    “word_document”,
                    “s3_object”,
                    “break”,
                    “section_break”,
                    “user_workflow”,
                    “system”,
                    “lc_message”,
                    “table”,
                    “array”,
                    “dynamic_group_json”,
                    “google_address_search”,
                    “json”,
                    “wizard_section”,
                    “pdf_viewer”,
                    “iframe”,
                    “visualization”
                ],
                “type”: “string”
              },
              “description”: “Field types to match for field selection.”
            },
            “is_required”: {
              “type”: “boolean”,
              “description”: “If true, selects mandatory fields; if false, selects
              optional fields.”
            },
            “is_filterable”: {
              “type”: “boolean”,
              “description”: “If true, selects fields that are filterable.”
            }
          }
        }
      }
    }
  “description”: “Returns a list of field reference objects from the workflow based on the
  given selection
  }
}
```

In an example invocation of the first large language model, the first prompt includes examples, a dictionary of functions and parameters, and additional text including user interface context and a natural language instruction as follows or like the following:
User Selection:
   User has currently selected ‘Initiate Request’ step under the ‘Business Requestor’ swimlane. Hence user is trying to perform actions related to this step only.
User's Prompt: Make the top 3 hidden fields optional.

In the foregoing example invocation, an example identification of a function and parameters may be produced in a structured format such as follows or like the following:

{

```
“function_arguments”: {
  “field_selection”: {
    “step”: “Initiate Request”,
    “stepgroup”: “Business Requestor”,
    “hidden”: true,
    “top_n”: 3
  }
},
“function_name”: “get_fields_by_selection”
```

}

In the foregoing example, “get_fields_by_selection” is the identified function and “field selection” including “step”, “stepgroup”, “hidden”, and “top_n” are identified parameters.

Function processor 330 invokes the function identified by the first large language model using the parameters identified by the first large language model. For example, the identified function may be called using the identified parameters. The function may, for example, be written in and executed using python or other interpreted programming language.

In the foregoing example, the get_fields_by_selection function may be implemented to parse a structured workflow representation to extract elements, such as fields according to the provided parameters. For example, if provided with the parameters given in the example provided with respect to the first large language model, the structured workflow representation may be parsed to find the top three fields that are hidden in the identified step and step group. The step and step group may identify a portion of the structured workflow representation. Other functions may also be implemented to handle other types of natural language instructions. An example output that may be produced by such a function in response to the foregoing example identification may be as follows or like the following:

The following are the top 3 (in that order) fields in the step Initiate Request under the stepgroup Business Requestor that are hidden.
1. Field name=“Send Invite Flag”, type=“char_field”
2. Field name=“Step ID”, type=“system”
3. Field name=“Group ID”, type=“system”

Second large language model 340 is invoked to generate an output instruction to update the structured workflow representation. The second large language model is invoked using a second prompt that includes the output (or a portion or modification thereof) from invoking the function and the natural language instruction. The second prompt may exclude the structured workflow representation. The second large language model 340 can generate the output instruction without utilizing the structured workflow representation as output by instead utilizing as context the output produced using the identified function. The output instruction may be produced to include a category, a sub-category, and a message according to a description of a syntax provided in the second prompt. For example, the syntax used to generate the output instruction may be parsed using regex. Such a format may reduce compute and memory requirements as compared to other formats by reducing the processing needed to parse the output instruction and/or by reducing the number of tokens included in the output instruction (e.g., as compared to a JavaScript Object Notation (JSON) format). In some implementations, the syntax utilizes, in order, an opening expression, the category, sub-category, and message separated by delimiters, and a closing expression. In some implementations, the following syntax, or a syntax similar to the following may be used: <msg>[category][sub-category]|[message]</msg>. An invocation of the second large language model using the foregoing example function output may include or be similar to the following: <msg>field|change|Make the “Send Invite Flag”, “Step ID” and “Group ID” in the ‘Initiate Request’ step under the ‘Business Requestor’ swimlane optional.</msg>

For example, a category may include an identification of the type of element which is to be operated upon, metadata, or other category of action, such as a field, field option, swimlane, step, or repositioning.

For example, a sub category may include an action to be performed with respect to the category, such as add, change, remove, or na (e.g., when no further categorization is needed, such as with respect to repositioning).

For example, a message may include a natural language instruction with specific elements of the structured workflow representation identified.

Structured workflow representation generation 350 may produce an updated structured workflow representation based on the output instruction that may be used to update or be merged with an existing structured workflow representation. For example, the updated structured workflow representation may be produced to indicate what changes should be made to the structured workflow representation which may be merged to produce a final output structured workflow representation implementing the changes. For example, structured workflow representation generation 350 may be implemented using a third large language model that takes as input a third prompt including the output instruction to produce the updated structured workflow representation.

As a first example, if the message in the output instruction is “Add a field with full width above ‘First Name’ field to Vendor-Personal Information step in Onboard User swimlane. It should be named as ‘Please provide your Date of Birth.’”, the third large language model may produce a updated structured workflow representation equal to or similar to the following:

```
{
  “fields”: [
    {
      “field”: {
        “body”: “Please provide your Date of Birth”,
        “field_type”: “date”,
        “size”: 1
      },
      “step”: “Vendor - Personal Information”,
      “stepgroup”: “Onboard User”,
      “position”: {
        “relation”: “before”,
        “reference”: “First Name”
      }
    }
  ]
}
```

As a second example, if the message in the output instruction is “Make ‘ABC’ field hidden.”, the third large language model may produce an updated structured workflow representation equal to or similar to the following:

```
{
  “change”: [
    {
      “field”: “ABC”,
      “hidden”: true
    }
  ]
}
```

The updated structured workflow representations of the foregoing examples can be used to update the existing structured workflow representation. For example, the field portion of the first example JSON representation above may be inserted into the existing structured workflow representation at a location identified by the step, stepgroup, and position properties. For example, for the second example JSON representation above, the ABC field in the existing structured workflow representation may be located and updated to include a hidden: true property. The updates to the existing structured workflow representation may be performed by a function designed to parse and interpret the JSON output from the third large language model (the updated structured workflow representation) and parse and modify the JSON of the existing structured workflow representation according to the interpretation of the updated structured workflow representation. The updates to the existing structured workflow representation generally will not be performed using a large language model due to context window and hallucination constraints of the large language model.

Depending on the implementation, variations of workflow platform 300 are possible. For example, depending on the implementation, components of workflow platform 300 may be different from what is shown and described, modified from what is shown or described, combined, split apart, or combinations thereof. For example, in some implementations, structured workflow representation generation 350 may be omitted or implemented elsewhere. The first large language model, second large language model, and third large language models referenced may be implemented using the same or different models, or the same or different instances of a particular model. Other variations of workflow platform 300 are possible.

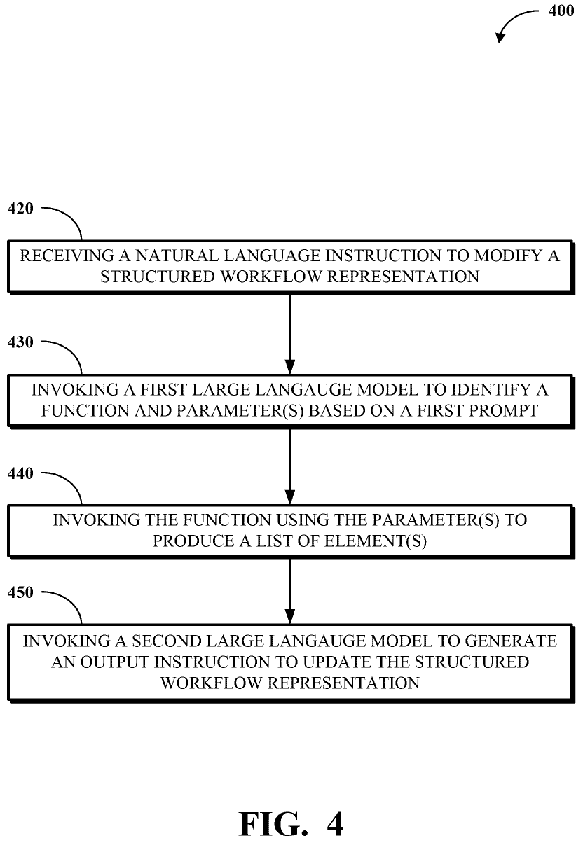

FIG. 4 is a flowchart of an example process 400 of workflow content extraction. The steps of FIG. 4 may be performed in a workflow system, such as workflow system 100 using one or more computing devices such as computing device 200. For example, steps of FIG. 4 may be performed by components of workflow platform 300 as depicted and described with respect to FIG. 3.

In step 420, process 400 includes receiving a natural language instruction to modify a structured workflow representation. For example, the natural language instruction may be transmitted from a user device, such as user device 104 to a server such as server 110 and may thus be received by a workflow system or platform. For example, the output of step 420 (e.g., the received natural language instruction) may be processed by step 430 and, if performed using workflow platform 300, may be provided to first large language model 320.

In step 430, process 400 includes invoking a first large language model to identify a function and parameter(s) based on a first prompt. For example, the function and one or more parameters are usable to specifically identify one or more elements referred to by a portion of the natural language instruction based on a first prompt including the natural language instruction and a description of available functions and available parameters. For example, the output of step 430 (e.g., the identified function and parameter(s)) may be processed by step 440 and, if performed using workflow platform 300, may be provided to function processor 330. Depending on the implementation, step 430 may include performing additional processes or steps, such as described above with respect to first large language model 320.

In step 440, process 400 includes invoking the function using the parameter(s) to produce a list of element(s). For example, the identified function may correspond to a function implemented in an interpretable language which may be executed using the identified parameters to produce the list of elements. For example, the output of step 440 (e.g., the list of elements) may be processed by step 450 and, if performed using workflow platform 300, may be provided to second large language model 340. Depending on the implementation, step 440 may include performing additional processes or steps, such as described above with respect to function processor 330.

In step 450, process 400 includes invoking a second large language model to generate an output instruction to update the structured workflow representation. For example, the invocation may be based on a second prompt including the natural language instruction and the list of one or more identified elements. For example, the output of step 450 (e.g., the identified function and parameter(s)) may be processed by step 450 and, if performed using workflow platform 300, may be provided to second large language model 340. Depending on the implementation, step 440 may include performing additional processes or steps, such as described above with respect to function processor 330.

Variations of process 400 including those that modify, add, or remove steps are possible. For example, an additional step may be performed to generate an updated structured workflow representation used to update the existing structured workflow representation (e.g., by merging the two JSON representations). For example, an additional step may be performed to interpret the structured workflow representation to produce a user interface depicting the workflow (or a portion thereof) represented by the structured workflow representation or to perform tasks in a workflow represented by the structured workflow representation. The process 400 can be executed using computing devices, such as the systems, hardware, and software described with respect to FIGS. 1-3. The process 400 can be performed, for example, by executing a machine-readable program or other computer-executable instructions, such as routines, instructions, programs, or other code used to implement steps of process 400 that are stored on a non-transitory computer readable medium. The steps, or operations, of the process 400 or another technique, method, process, or algorithm described in connection with the implementations disclosed herein can be implemented directly in hardware, firmware, software executed by hardware, circuitry, or a combination thereof.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, Python, Ruby, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to hardware, mechanical or physical implementations, but can include software routines implemented in conjunction with hardware processors, etc. Likewise, the terms “system” or “tool” as used herein and in the figures, but in any event based on their context, may be understood as corresponding to a functional unit implemented using software, hardware (e.g., an integrated circuit, such as an application specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A computer-implemented method comprising:
receiving a natural language instruction to modify a structured workflow representation;
invoking a first large language model to identify a function and one or more parameters usable to specifically identify one or more elements referred to by a portion of the natural language instruction based on a first prompt including the natural language instruction and a description of available functions and available parameters;
invoking the function using the one or more parameters to produce a list of one or more identified elements; and
invoking a second large language model to generate an output instruction to update the structured workflow representation based on a second prompt including the natural language instruction and the list of one or more identified elements.

2. The method of claim 1, wherein the second large language model generates the output instruction without utilizing the structured workflow representation as input.

3. The method of claim 2, further comprising:
modifying the structured workflow representation based on the output instruction.

4. The method of claim 2, wherein the second prompt includes a description of a syntax to be used to generate the output instruction including a category, a sub-category, and a message.

5. The method of claim 4, wherein the second prompt includes the natural language instruction as a question after the list of one or more identified elements.

6. The method of claim 5, wherein the second prompt includes text instructing the second large language model to utilize the list of one or more identified elements when generating the output instruction.

7. The method of claim 6, wherein the syntax to be used to generate the output instruction is parsed using regex.

8. The method of claim 7, wherein the syntax to be used to generate the output instruction utilizes, in order, an opening expression, the category, sub-category, and message separated by delimiters, and a closing expression.

9. The method of claim 2, wherein the first prompt includes a series of examples mapping an example natural language instruction to an example function and example one or more parameters.

10. A non-transitory computer readable medium including instructions that, when executed by one or more processors, cause the one or more processors to perform the following steps:
receiving a natural language instruction to modify a structured workflow representation;
invoking a first large language model to identify a function and one or more parameters usable to specifically identify one or more elements referred to by a portion of the natural language instruction based on a first prompt including the natural language instruction and a description of available functions and available parameters;
invoking the function using the one or more parameters to produce a list of one or more identified elements; and
invoking a second large language model to generate an output instruction to update the structured workflow representation based on a second prompt including the natural language instruction and the list of one or more identified elements.

11. The non-transitory computer readable medium of claim 10, wherein the second large language model generates the output instruction without utilizing the structured workflow representation as input.

12. The non-transitory computer readable medium of claim 11, further comprising instructions that, when executed by one or more processors, cause the one or more processors to perform the following steps:
modifying the structured workflow representation based on the output instruction.

13. The non-transitory computer readable medium of claim 11, wherein the second prompt includes a description of a syntax to be used to generate the output instruction including a category, a sub-category, and a message.

14. The non-transitory computer readable medium of claim 13, wherein the second prompt includes the natural language instruction as a question after the list of one or more identified elements.

15. The non-transitory computer readable medium of claim 14, wherein the second prompt includes text instructing the second large language model to utilize the list of one or more identified elements when generating the output instruction.

16. An apparatus including at least one processor and at least one computer readable medium including instructions that, when executed by the one or more processors, cause the processor to perform the following steps:
receiving a natural language instruction to modify a structured workflow representation;
invoking a first large language model to identify a function and one or more parameters usable to specifically identify one or more elements referred to by a portion of the natural language instruction based on a first prompt including the natural language instruction and a description of available functions and available parameters;
invoking the function using the one or more parameters to produce a list of one or more identified elements; and
invoking a second large language model to generate an output instruction to update the structured workflow representation based on a second prompt including the natural language instruction and the list of one or more identified elements.

17. The apparatus of claim 16, wherein the second large language model generates the output instruction without utilizing the structured workflow representation as input.

18. The apparatus of claim 17, further comprising instructions that, when executed by the one or more processors, cause the processor to perform the following steps:
modifying the structured workflow representation based on the output instruction.

19. The apparatus of claim 17, wherein the second prompt includes a description of a syntax to be used to generate the output instruction including a category, a sub-category, and a message.

20. The apparatus of claim 19, wherein the second prompt includes the natural language instruction as a question after the list of one or more identified elements.
